(19) United States
(12) Patent Application Publication
(10) Pub. No.: US 2021/0281484 A1
(43) Pub. Date: Sep. 9, 2021

(54) DYNAMIC DEVICE CONFIGURATION AND DEPLOYMENT

(71) Applicant: ZEBRA TECHNOLOGIES CORPORATION, Lincolnshire, IL (US)

(72) Inventors: Matthew Louis Kowalski, Merrick, NY (US); Nicole Daphne Tricoukes, Seaford, NY (US); Michael J. Giannetta, Centerport, NY (US)

(21) Appl. No.: 16/810,110

(22) Filed: Mar. 5, 2020

(51) Int. Cl. H04L 12/24

(52) U.S. Cl. CPC H04L 41/0886; H04L 41/0889

(57) ABSTRACT

A system includes: a holder having a plurality of bays each configured to support a respective one of a plurality of electronic devices, and a notification assembly associated with the plurality of bays; a computing device connected with the holder and having a processor configured to: obtain an operator identifier, obtain status information for each of the plurality of electronic devices, based on the status information, select one of the plurality of electronic devices; and send, to the holder, an identifier of the selected electronic device and a configuration profile corresponding to the operator identifier; wherein the holder is configured, in response to receipt of the identifier of the selected electronic device and the configuration profile, to: deploy the configuration profile to the selected electronic device via a corresponding one of the bays, and activate the notification assembly to indicate the corresponding one of the bays to the operator.

### BACKGROUND

Environments such as warehouses, factories, health care facilities and the like may equip workers with electronic devices selected from a fleet of such devices. In some implementations, the electronic devices may not prompt workers for identification to distinguish between workers. In such implementations, workers may therefore be required to perform time-consuming configuration of a device prior to beginning the performance of their tasks.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic of a system for dynamic device configuration and deployment.

FIG. 2 is a block diagram of certain internal hardware components of the computing device of FIG. 1.

FIG. 3 is a flowchart of a method of dynamic device configuration and deployment.

FIG. 4 is a schematic illustrating an example performance of block 305 of the method of FIG. 3.

FIG. 5 is a schematic illustrating an example performance of block 330 of the method of FIG. 3.

FIG. 6 is a schematic illustrating a device deployed following a performance of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a system, comprising: a holder having: a plurality of bays each configured to support a respective one of a plurality of electronic devices, and a notification assembly associated with the plurality of bays; a computing device connected with the holder and having a processor configured to: obtain an operator identifier, obtain status information for each of the plurality of electronic devices, based on the status information, select one of the plurality of electronic devices; and send, to the holder, (i) an identifier of the selected electronic device and (ii) a configuration profile corresponding to the operator identifier; wherein the holder is configured, in response to receipt of the identifier of the selected electronic device and the configuration profile, to: deploy the configuration profile to the selected electronic device via a corresponding one of the bays, and activate the notification assembly to indicate the corresponding one of the bays to the operator.

Additional examples disclosed herein are directed to a method, comprising: obtaining an operator identifier at a computing device connected to a holder having a plurality of bays each configured to support a respective one of a plurality of electronic devices; obtaining status information for each of the plurality of electronic devices; based on the status information, selecting one of the plurality of electronic devices; sending, to the holder, (i) an identifier of the selected electronic device and (ii) a configuration profile corresponding to the operator identifier; at the holder, in response to receipt of the identifier of the selected electronic device and the configuration profile: deploying the configuration profile to the selected electronic device via a corresponding one of the bays, and activating a notification assembly to indicate the corresponding one of the bays to the operator.

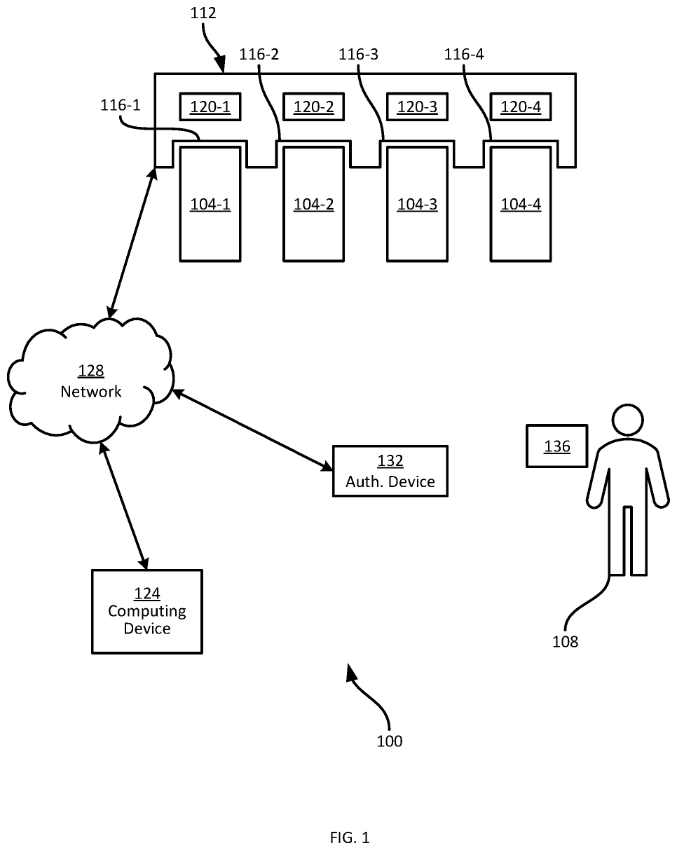

FIG. 1 depicts a system 100 for dynamic device configuration and deployment. The system 100 includes a plurality of electronic devices 104, of which four examples 104-1, 104-2, 104-3 and 104-4 are shown in FIG. 1. In other implementations, fewer devices 104 than the four shown may be deployed, or a greater number of devices 104 may be deployed. The devices 104 represent a fleet from which a device 104 is selected by each of a plurality of workers, also referred to as operators, such as the example operator 108 shown in FIG. 1. For example, prior to beginning a shift, a group of operators may each select a device 104 from the pool, for use during the shift to perform any of a wide variety of tasks.

The devices 104 are therefore not permanently assigned to specific operators, but instead may be operated by different operators at different times. The devices 104 may also be configurable. For example, the devices 104 can be heads-up display units (HUDs), virtual reality headsets, or the like including at least one display to present information to the operator 108 during use. Configuration for such devices 104 can include any one or more of a focal distance, display brightness, transparency (e.g. of HUD information relative to the surroundings of the operator), audio settings such as left/right balance and/or equalizer settings, gaze tracking, a magnification level, interocular distance, applications to launch automatically, and the like.

Configuration of the devices 104 may be time consuming, and may vary between operators. The system 100 therefore includes components enabling identification of the operator 108 and retrieval of stored configuration settings corresponding to the operator 108, to reduce the time spent by the operator 108 to configure a device 104 prior to use of the device 104.

In addition, the devices 104 may be similar in appearance, but may have differing capabilities. The differences in capabilities may be transient, such as remaining battery charge, pending software updates and the like. Certain differences in capabilities may also be static, such as the suite of sensors included in a given device 104 (e.g. a barcode scanner and a range finder) in comparison with the suite of sensors of another device 104 (e.g. a barcode scanner, but no range finder). Other examples of differing capabilities include computational resources such as CPU speed, memory capacity, and the like. Further, the tasks performed by the operator 108 may vary over time, and different operators 108 may be assigned different types of tasks, requiring different capabilities of the devices 104. The system 100 therefore also, as will be discussed in greater detail below, enables the selection of a device 104 from the pool of available devices 104 according to the capabilities of the devices 104 and the capabilities required by the operator 108.

The system 100 includes a holder 112, which may also be referred to as a rack, that includes a plurality of bays 116-1, 116-2, 116-3 and 116-4 that support the devices 104. The bays 116 can take any of a variety of forms, depending on the shape and size of the devices 104. In general, the bays 116 are configured to physically support the devices 104 and to provide power and data connectivity between the devices 104 and the holder 112. The holder 112 also includes a notification device, which in the illustrated example is implemented as a set of indicator lights 120-1, 120-2, 120-3 and 120-4 corresponding to respective bays 116. The indicator lights 120 can be controlled by the holder 112 to notify the operator 108 of a selected one of the devices 104 to retrieve from the holder 112 for use. For example, the indicator lights 120 can be placed in physical proximity to corresponding bays 116.

Various other notification devices are also contemplated, such as a display controllable to indicate (e.g. by number, image or the like) from which bay 116 the operator 108 is to retrieve a device 104), a speaker, and the like. The notification device can also indicate other information beyond which device 104 is intended to be retrieved by the operator 108. For example, the indicator lights 120 can be controllable to emit light in various colors and/or patterns to indicate device status (e.g. whether a device 104 is charging, receiving a software update, or the like).

The system 100 further includes a computing device 124 connected with the holder 112 via a network 128 (e.g. any suitable combination of local and wide-area networks, including the Internet). The computing device 124 is configured, as will be discussed below, to maintain configuration settings for the devices 104 that correspond to each of a number of operators, including the operator 108 shown in FIG. 1. The computing device 104 is also configured to obtain status information associated with the devices 104, and in some examples operational parameters associated with the operator 108. The computing device 104 is configured to select a device 104 from those supported by the holder 112, for use by the operator 108. The computing device 124 is further configured to send instructions to the holder 112 to load an operator-specific configuration to the selected device 104, and to notify the operator 108 (e.g. via the indicator lights 120) of the selected device 104.

To perform the above functions, the computing device 124 is also configured to obtain an identifier of the operator 108. To that end, the system 100 includes an authentication device 132, which can be integrated with the holder 112, or deployed as an independent device from the holder 112. In some examples, the authentication device 132 obtains the operator identifier from a token 136 carried by the operator 108. The token 136 can include a radio frequency identification (RFID)-equipped badge, fob, ID card, or the like. The token can also include a card containing a magnetic strip, bearing a barcode or other machine-readable indicium, or the like. The authentication device 132 can therefore include one or more sensors to detect the token 136 and obtain the operator identifier therefrom. Examples of such sensors include a barcode scanner, an RFID antenna, a camera, a magnetic stripe reader, and the like. In other examples, the authentication device 132 can include a biometric sensor such as a fingerprint reader, and the operator 108 can provide biometric identification rather than the token 136.

The authentication device 132 is connected to the network 128, and can therefore provide the operator identifier to the computing device 124, enabling the computing device 124 to select and configure a device 104 for the operator 108 at the holder 112.

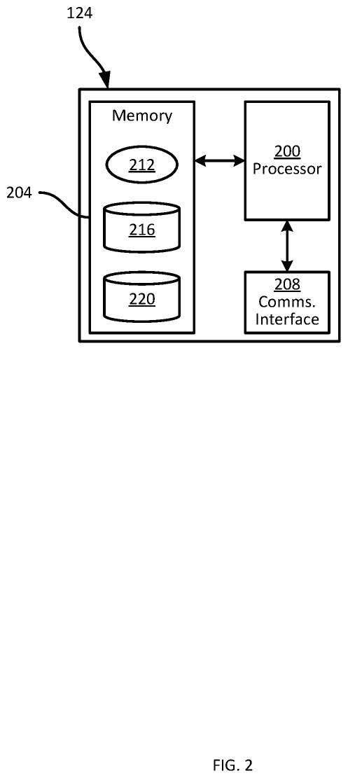

Turning to FIG. 2, certain internal components of the computing device 124 are illustrated. The computing device 124 includes a controller, such as a processor 200, interconnected with a non-transitory computer readable storage medium, such as a memory 204. The memory 204 includes a combination of volatile memory (e.g. Random Access Memory or RAM) and non-volatile memory (e.g. read only memory or ROM, Electrically Erasable Programmable Read Only Memory or EEPROM, flash memory). The processor 200 and the memory 204 each comprise one or more integrated circuits. The computing device 124 also includes a communications interface 208 enabling the computing device 124 to exchange data with other devices such as the holder 112 and the authentication device 132, e.g. via the network 128.

The memory 204 stores computer readable instructions for execution by the processor 200. In particular, the memory 204 stores a device configuration application 212 which, when executed by the processor 200, configures the processor 200 to select a device 104 for use by the operator 108 as outlined above. Those skilled in the art will appreciate that the functionality implemented by the processor 200 via the execution of the application 212 may also be implemented by one or more specially designed hardware and firmware components, such as FPGAs, ASICs and the like in other embodiments.

The memory 204 can also store an operator repository 216, containing data associated with the operator 108 and other operators. In particular, as will be discussed below, the repository 216 can contain a configuration profile corresponding to the operator 108. More generally, the repository 216 can contain configuration profiles for each operator that uses the system 100. Configuration profiles contain configuration settings for the devices 104, such as those mentioned earlier. The repository 216 can also contain other operator-related information, such as an indication of the tasks, or types of tasks, to be performed by each operator, shift lengths for each operator, and the like.

In addition, the memory 204 can store a device repository 220, containing data associated with the devices 104. For example, the repository 220 can include, for each device 104, indications of both transient capabilities such as current battery levels, and static capabilities such as computational resources, available sensor suites, and the like. The computing device 124 can be configured to select and configure a device 104 for use by the operator 108 based on the contents of each of the repositories 216 and 220.

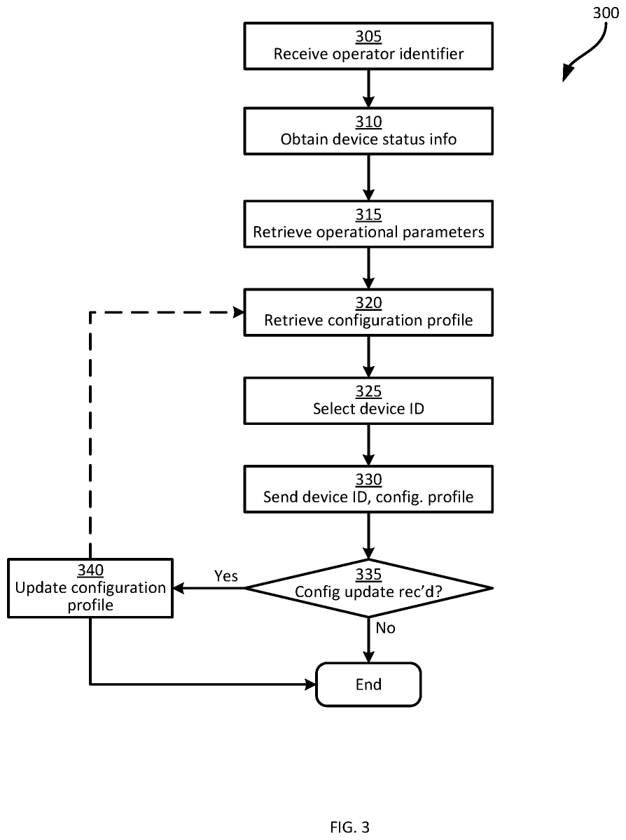

Turning now to FIG. 3, the functionality implemented by the computing device 124 will be discussed in greater detail. FIG. 3 illustrates a device configuration and deployment method 300, which will be discussed below in conjunction with its performance by the computing device 124 in the system 100.

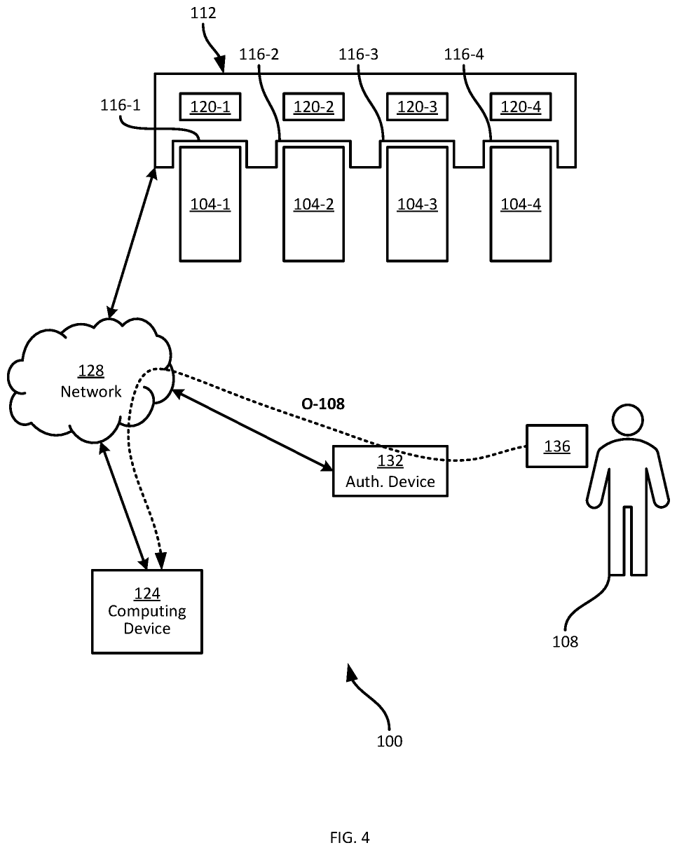

At block 305, the computing device 124 obtains an operator identifier corresponding to the operator 108. In the present example, referring briefly to FIG. 4, the operator identifier is received via the network 128 from the authentication device 132. The authentication device 132, in turn, receives the operator identifier from the operator 108, e.g. via presentation of the token 136 to the authentication device 132. As shown in FIG. 4, the operator identifier “0-108” is received at the authentication device 132 and transmitted to the computing device 124 via the network 128.

At block 310, the computing device 124 is configured to obtain device status information for each of the devices 104 currently supported by the holder 112. At least a portion of the device status information can be obtained by transmitting a request to the holder 112 in response to receiving the operator identifier at block 305. In other examples, the computing device 124 can be configured to periodically request device status information. In further examples, the holder 112 can be configured to periodically transmit device status information to the computing device 124. The device status information received from the holder 112 can include battery levels and other device health indicators (e.g. whether a software update is being installed on a device 104, rendering the device 104 temporarily inoperable).

Additional device status information can also be obtained at block 310 from the repository 220 shown in FIG. 2. The device status information obtained at block 310 can therefore include identifiers of the devices 104, as well as transient status information such as battery levels, and static status information such as capability indicators (e.g. representing computational resources, sensor suites and the like available to each device 104).

At block 315, the computing device 124 can be configured to retrieve operational parameters corresponding to the operator 108 identified at block 305. The operational parameters are retrieved from the repository 216 and can include, for example, a shift length (e.g. 8 hours). The operational parameters can also include a type of task or types of tasks currently assigned to the operator 108. For example, the operational parameters may indicate a level of complexity for the tasks allocated to the operator 108 to perform with the device 104 selected via the method 300. For example, one of a predetermined set of complexity levels (e.g. low, medium, high) can be stored in the repository 216 in connection with the operator identifier 0-108. The complexity levels may indicate a level of computational resources required by the selected device 104 to enable the operator 108 to perform their assigned tasks.

In other example performances of the method 300, the retrieval of operational parameters at block 315, and their subsequent use in device selection, can be omitted.

At block 320, the computing device 124 is configured to retrieve a configuration profile from the repository 216. As will be seen below, configuration settings applied to any of the devices 104 by an operator 108 during use are stored in the repository 216 in connection with an identifier of that operator 108. The repository 216 may therefore contain a set of configuration settings in association with the operator identifier 0-108 received at block 305. When the repository 216 does not contain a configuration profile for the operator identified at block 305 (e.g. because the operator from block 305 has not yet configured a device 104), block 320 may be omitted.

At block 325, the computing device 124 is configured to select a device 104 from among the devices 104 currently supported by the holder 112. The selection at block 325 is made based at least on the device status information obtained at block 310. For example, the computing device 124 can be configured to select the device 104 with the greatest battery charge level and with no health indicators signifying that the device 104 is temporarily inoperable.

In other examples, when operational parameters such as a task type assigned to the operator from block 305 are available, the selection at block 325 is based on both the device status information and the operational parameters. For example, the computing device 124 can select a subset of the devices 104 that can accommodate the complexity level indicated in the operational parameters from block 315. From that subset, the computing device 124 can then select a device 104 with a battery level that satisfies a shift length from the operational parameters. For example, the computing device 124 can select the device 104 with the lowest battery level that satisfies the shift length.

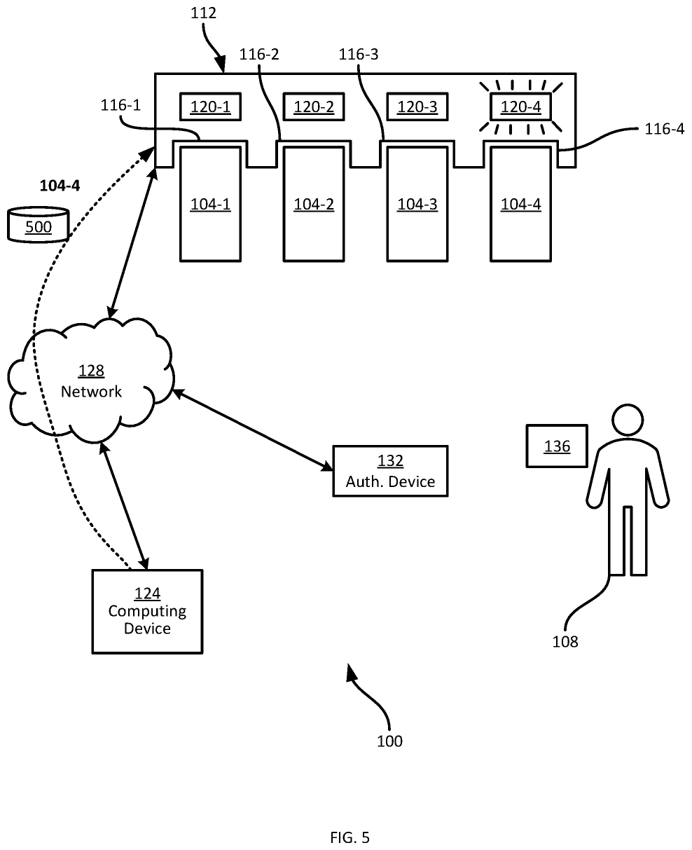

At block 330, having selected a device identifier at block 325, the computing device 124 is configured to transmit at least the selected device identifier to the holder 112. When a configuration profile is available at block 320, the computing device 124 also transmits the configuration profile to the holder 112 at block 330. Turning to FIG. 5, the computing device 124 is shown transmitting an instruction to the holder 112 via the network 128 that contains the device identifier “104-4” and a configuration profile 500 extracted from the repository 216. The configuration profile 500 includes configuration settings previously selected by the operator 108 for application to the devices 104.

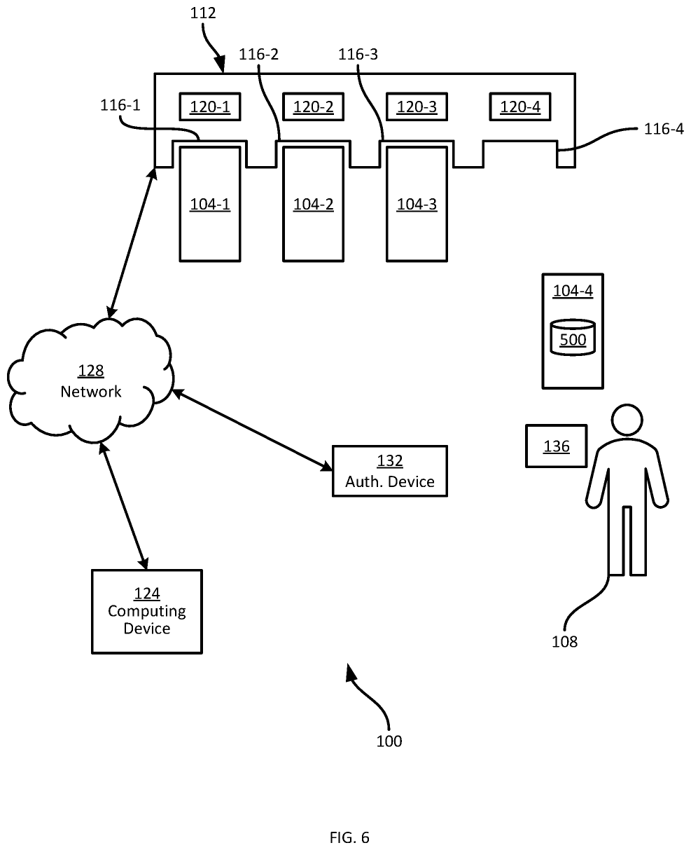

In response to the instruction sent at block 330, the holder 112 is configured to generate a notification to the operator 108 indicating the selected device 104. In the example shown in FIG. 5, the holder 112 controls the indicator light 120-4 corresponding to the bay 116-4 (where the device 104-4 is placed) to flash, illuminate, or the like. The holder 112 also transmits the configuration profile 500 to the device 104-4 to configure the device 104-4 for use by the operator 108. Referring to FIG. 6, the device 104-4 is shown following configuration and removal from the holder 112 by the operator 108. In particular, the configuration profile 500 is stored at the device 104-4 itself.

Returning to FIG. 3, at block 335 the computing device 124 is configured to determine whether the configuration profile 500 has been updated. As will be apparent to those skilled in the art, the configuration settings at the device 104-4 can be modified by the operator 108 during use. In other words, the configuration profile 500 can be modified by the operator 108. The devices 104 can be configured to transmit an updated version of the configuration profile 500 to the computing device 124, e.g. via the network 128, during use by the operator 108. In other examples, the devices 104 transmit updated configuration profiles to the computing device 124 via the holder 112 in response to being returned to the holder 112.

When the determination at block 335 is affirmative, at block 340 the computing device 124 updates the repository 216, storing the updated configuration profile in association with the operator identifier from block 305. As a result, subsequent performances of the method 300 for the same operator 108, as indicated by the dashed line in FIG. 3, result in loading of the updated configuration profile to the selected device 104. When the determination at block 335 is negative, the performance of the method 300 ends.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A system, comprising:
a holder having:
a plurality of bays each configured to support a respective one of a plurality of electronic devices, and
a notification assembly associated with the plurality of bays;
a computing device connected with the holder and having a processor configured to:
obtain an operator identifier,
obtain status information for each of the plurality of electronic devices,
based on the status information, select one of the plurality of electronic devices; and
send, to the holder, (i) an identifier of the selected electronic device and (ii) a configuration profile corresponding to the operator identifier;
wherein the holder is configured, in response to receipt of the identifier of the selected electronic device and the configuration profile, to:
deploy the configuration profile to the selected electronic device via a corresponding one of the bays, and
activate the notification assembly to indicate the corresponding one of the bays to the operator.

2. The system of claim 1, further comprising an authentication device;
wherein the processor is configured to obtain the operator identifier from the authentication device.

3. The system of claim 2, wherein the authentication device is integrated with the holder; and wherein the processor is configured to obtain the operator identifier via the holder.

4. The system of claim 1, wherein the processor is further configured, in order to obtain the status information for each device, to:
receive a device identifier and battery information from the holder; and
retrieve device attributes from a device repository according to the device identifier.

5. The system of claim 4, wherein the device attributes include an indicator of computational resources.

6. The system of claim 4, wherein the processor is further configured to:
obtain operational parameters according to the operator identifier; and
select the one of the plurality of electronic devices based on the status information and on the operational parameters.

7. The system of claim 6, wherein the operational parameters include at least one of a shift length, and a task type indicator.

8. The system of claim 1, wherein the processor is further configured to:
receive an updated configuration profile corresponding to the operator identifier; and
replace the configuration profile with the updated configuration profile.

9. The system of claim 8, wherein the processor is further configured to receive the updated configuration profile from the selected electronic device.

10. The system of claim 8, wherein the processor is further configured to receive the updated configuration profile from the holder in response to return of the selected electronic device to the holder.

11. A method, comprising:
obtaining an operator identifier at a computing device connected to a holder having a plurality of bays each configured to support a respective one of a plurality of electronic devices;
obtaining status information for each of the plurality of electronic devices;
based on the status information, selecting one of the plurality of electronic devices;
sending, to the holder, (i) an identifier of the selected electronic device and (ii) a configuration profile corresponding to the operator identifier;
at the holder, in response to receipt of the identifier of the selected electronic device and the configuration profile:
deploying the configuration profile to the selected electronic device via a corresponding one of the bays, and
activating a notification assembly to indicate the corresponding one of the bays to the operator.

12. The method of claim 11, wherein obtaining the operator identifier includes receiving the operator identifier from an authentication device.

13. The method of claim 12, wherein the authentication device is integrated with the holder; and wherein obtaining the operator identifier includes receiving the operator identifier via the holder.

14. The method of claim 11, wherein obtaining the status information for each device includes:
receiving a device identifier and battery information from the holder; and
retrieving device attributes from a device repository according to the device identifier.

15. The method of claim 14, wherein the device attributes include an indicator of computational resources.

16. The method of claim 14, further comprising:
obtaining operational parameters according to the operator identifier; and
selecting the one of the plurality of electronic devices based on the status information and on the operational parameters.

17. The method of claim 16, wherein the operational parameters include at least one of a shift length, and a task type indicator.

18. The method of claim 11, further comprising:
receiving an updated configuration profile corresponding to the operator identifier; and
replacing the configuration profile with the updated configuration profile.

19. The method of claim 18, further comprising receiving the updated configuration profile from the selected electronic device.

20. The method of claim 18, further comprising receiving the updated configuration profile from the holder in response to return of the selected electronic device to the holder.
